(19) United States
(12) Patent Application Publication
(10) Pub. No.: US 2016/0159222 A1
(43) Pub. Date: Jun. 9, 2016

(54) APPARATUS AND METHOD FOR INSPECTING CHARGING SYSTEM OF ELECTRIC VEHICLE

(71) Applicant: Kia Motors Corporation, Seoul (KR)

(72) Inventors: Yong Cheol Kim, Gwangju (KR); Gab Su Kim, Gwangju (KR); Young Oh Kim, Gwangju (KR)

(21) Appl. No.: 14/664,816

(22) Filed: Mar. 21, 2015

(30) Foreign Application Priority Data
Dec. 9, 2014 (KR) 10-2014-0176055

(51) Int. Cl. B60L 3/12; B60L 11/18

(52) U.S. Cl. CPC B60L 3/12; B60L 11/1809

(57) ABSTRACT

An apparatus and method for inspecting a charging system of an electric vehicle are provided. The apparatus and method inspect the charging system to determine whether the charging system of the electric vehicle on an electric vehicle assembly line operates without error. In particular, a communication section within the electric vehicle is inspected based on a controller area network (CAN) communication, while charging currents are gradually increased, and the subsequent charging parameter curves and waveforms are monitored.

### CROSS-REFERENCE TO RELATED APPLICATION

This application is based on and claims the benefit of priority to Korean Patent Application No. 10-2014-0176055, filed on Dec. 9, 2014 in the Korean Intellectual Property Office, the disclosure of which is incorporated herein in its entirety by reference.

### TECHNICAL FIELD

The present disclosure relates to an apparatus and method for inspecting a charging system of an electric vehicle, and more particularly, to a technology for inspecting whether the charging system within the electric vehicle operates normally (e.g., without error or failure), on an electric vehicle assembly line.

### BACKGROUND

Generally, electric vehicle uses a high voltage battery as a power source. Accordingly, when the charging system configured to charge and monitor the high voltage battery is malfunctioning, the overall performance of the electric vehicle is affected. It is thus essential to adopt a process of inspecting or monitoring the charging system of electric vehicle during mass production thereof.

### SUMMARY

The present disclosure provides an apparatus and method for inspecting whether a charging system of an electric vehicle operates normally (e.g., without error or failure), on an electric vehicle assembly line, which inspect a communication section within the electric vehicle based on a controller area network (CAN) communication, supply charging currents while gradually increasing the same, and inspect the charging system by monitoring subsequent charging parameter curve and waveforms. The communication section includes a wiring and a connector between a charging inlet and a battery management system (BMS) of an electric vehicle, and the BMS, while the charging system includes a wiring and a connector between the BMS and a high voltage battery, and a circuit of the high voltage battery.

Objects of the present disclosures are not limited to any specific examples mentioned above, but these and other objects and advantages of the present disclosures not specified herein can be understood based on the explanation provided below and will be more apparent based on the embodiments of the present disclosure. Further, it will be easily appreciated that the objects and advantages of the present disclosures can be achieved by the means of the claims and combinations thereof.

According to an exemplary embodiment of the present disclosure, an apparatus for inspecting a charging system of an electric vehicle may include a vehicle model recognizer configured to recognize a vehicle model (e.g., vehicle type) disposed on an electric vehicle assembly line, a connection portion connected to a charging inlet of the electric vehicle, a communicator configured to communicate with a battery management system (BMS) within the electric vehicle via the connection portion, a charger configured to supply charging currents to the BMS via the connection portion, and an inspector configured to perform inspection on the charging system of the electric vehicle, based on set data corresponding to the vehicle model as recognized by the vehicle model recognizer.

Further, according to an exemplary embodiment of the present invention, a method of inspecting a charging system of an electric vehicle may include recognizing, by a vehicle model recognizer, a vehicle model disposed on an electric vehicle assembly line, connecting, by a connection portion, to a charging inlet of the electric vehicle, communicating, by a communicator, with a battery management system (BMS) within the electric vehicle, supplying, by a charger, charging currents to the BMS via the connection portion, and inspecting, by an inspector, the charging system of the electric vehicle based on set data corresponding to the recognized vehicle model.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary block diagram of an electric vehicle according to an exemplary embodiment of the present disclosure;

FIG. 2 is an exemplary block diagram of an apparatus for inspecting a charging system of an electric vehicle according to an exemplary embodiment of the present disclosure;

FIG. 3 is an exemplary detailed block diagram of an inspector according to an exemplary embodiment of the present disclosure; and

FIG. 4 is an exemplary flowchart illustrating a method of inspecting a charging system of an electric vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the tem “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The above objects, characteristics and advantages will be made more apparent in view of the detailed description provided below with reference to the accompanying drawings, thus allowing those skilled in the art to easily embody the technical concept of the present disclosure. In the following description, well-known technologies are not described in detail since they would obscure the invention with unnecessary detail. An exemplary embodiment of the present disclosure will be described in detail with reference to the accompanying drawings.

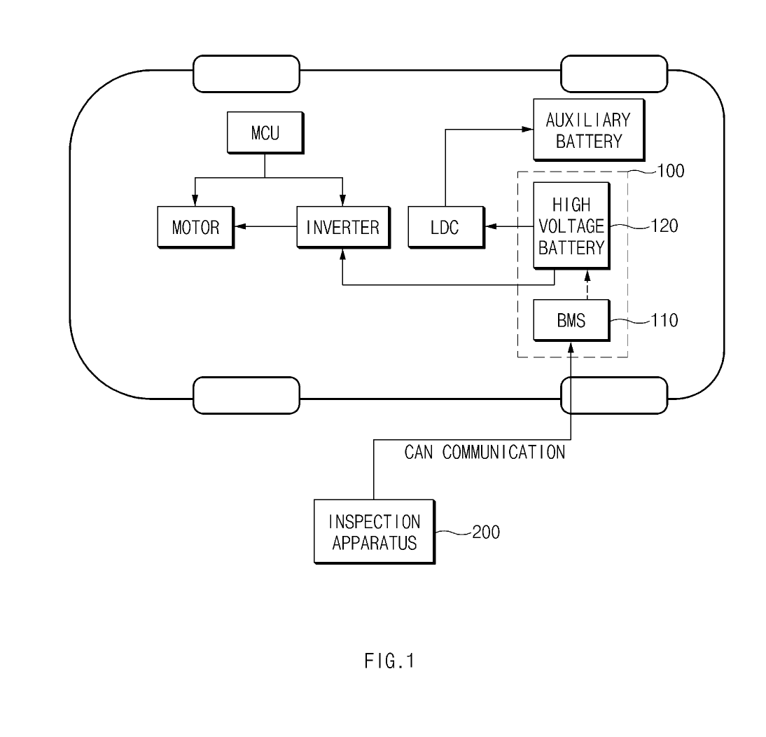

FIG. 1 is an exemplary block diagram of an electric vehicle according to an exemplary embodiment of the present disclosure. Referring to FIG. 1, an electric vehicle according to an exemplary embodiment of the present disclosure may include a charging system 100 having a BMS 110 and a high voltage battery 120. Additionally, although not illustrated in the drawings, the electric vehicle may additionally include a wiring and a connector between a charging inlet and the BMS of the electric vehicle as a communication section, and include a wiring and a connector between the BMS and the high voltage battery, and a circuit of the high voltage battery as a charging section.

The BMS 110 may be configured to receive a wakeup signal from an apparatus 200 (referred to as, “inspection apparatus 200”) for inspecting the charging system according to an exemplary embodiment, and may be configured to provide a notification indicating that the CAN communication is normal (e.g., without error), by transmitting a corresponding response signal (i.e., Low signal) to the inspection apparatus 200 via the CAN communication. Further, the BMS 110 may be configured to charge the high voltage battery 120 based on the charging currents applied from the inspection apparatus 200 according to an exemplary embodiment, detect charging parameter curves and waveforms, and transmit the same via the CAN communication to the inspection apparatus 200.

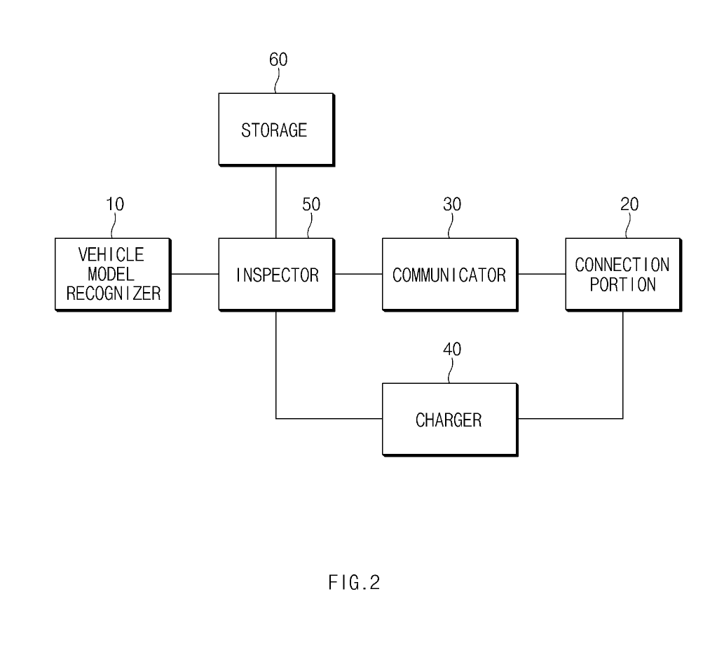

FIG. 2 is an exemplary block diagram of an apparatus for inspecting a charging system of an electric vehicle according to an exemplary embodiment of the present disclosure. As illustrated in FIG. 2, the apparatus for inspecting a charging system of an electric vehicle according to an exemplary embodiment of the present disclosure may include a vehicle model recognizer 10, a connection portion 20, a communicator 30, a charger 40, an inspector 50, and a storage 60. The various elements of the charging system may be executed by a controller. To explain the above components in detail, first, the vehicle model recognizer 10 may be configured to recognize a model of the vehicle (e.g., a vehicle type) disposed on (e.g., placed onto) the electric vehicle assembly line. For example, the vehicle model recognizer 10 may be configured to recognize the vehicle model based on a barcode, or by radio frequency identification (RFID) manner. The vehicle model recognizer 10 may be executed by the controller.

Additionally, the connection portion 20 may be a type of coupler that connects the inspection apparatus 200 to a charging inlet of the electric vehicle. The charging inlet may include a communication port and a charge port, thus allowing communication between the inspection apparatus 200 and the BMS 110 as well as charging therebetween. The communicator 30, such as a CAN communication module, may be configured to communicate with the BMS 110 within the electric vehicle via the connection portion 10 under control of the inspector 50, executed by the controller. In other words, upon connection of the connection portion 20 to the charging inlet of the electric vehicle, the communicator 30 may be configured to exchange CAN signals with the BMS 110 of the electric vehicle to detect whether the CAN communication operates normally (e.g., operates without error or failure). The communicator 30 may be configured to exchange CAN signals to inspect abnormality or malfunction of the communication system involved in CAN communication. The duration may be within about two seconds.

Further, the communication portion 30 may be configured to receive charging parameter curve from the BMS 110. The charger 40, such as a power supply module, may be configured to supply charging currents to the BMS 110 within the electric vehicle, via the connection portion 10 and under control of the inspector 50. In other words, the charger 40 may be configured to supply charging currents to the BMS 110 within the electric vehicle when the CAN communication with the BMS 110 within the electric vehicle is performed normally. The inspector 50 may be executed by a controller to operate the respective components to execute the various functions of the components without error.

Particularly, the inspector 50 may be configured to inspect the charging system based on the set data (e.g., communication scheme, charging scheme) that corresponds to the vehicle model as recognized by the vehicle model recognizer 10. In other words, the inspector 50 may be configured to operate the communicator 30 to attempt communication with the BMS 110 within the electric vehicle by a communication scheme that corresponds to the subject vehicle model of the inspection. The communication scheme may include controller area network (CAN), local interconnect network (LIN), FlexRay, media oriented system transport (MOST), etc. Hereinbelow, the CAN communication will be explained as an example.

Further, the inspector 50 may be configured to operate the charger 40 to supply the charging currents in a charging scheme that corresponds to the subject vehicle model of inspection, based on whether the CAN communication with the BMS 110 of the electric vehicle operates normally. The charging scheme may gradually (e.g., linearly) increase the charging currents for a predetermined time. For example, the predetermined time may be about 20 seconds, and the initial charging currents may be about 40 A and the final charging currents may be about 60 A. In particular, the charging currents may be increased linearly by about 1 A per 1 second.

Moreover, upon receiving charging parameter curve according to the supply of the charging currents from the BMS 110 of the electric vehicle, the inspector 50 may be configured to compare the received curve with the reference parameter to determine whether the charging system operates normally. The inspector 50 may then be configured to store the result of inspection on the charging systems within the respective electric vehicles to the storage 60. Additionally, the present disclosure may additionally include a personal computer (PC) connection portion (not illustrated) to allow transmission of the result of inspection stored at the storage 60 to the PC and also to enable history management thereof.

As described above, the present disclosure may be able to guarantee and inspect the charging performance of the electric vehicles with increased accuracy, by inspecting the BMS 110 with CAN communication and actually performing the charging. Further, the present disclosure may be used in vehicle mass production factories which aim for improved quality as well as mass production. In other words, the present technology may ensure optimized work time for inspection process, and enables quality inspection on the charging performance of the electric vehicles for which mass production is ensured. Additionally, the present disclosure may maximize efficiency by performing electric vehicle performance inspection on a wider area within a shorter period of time.

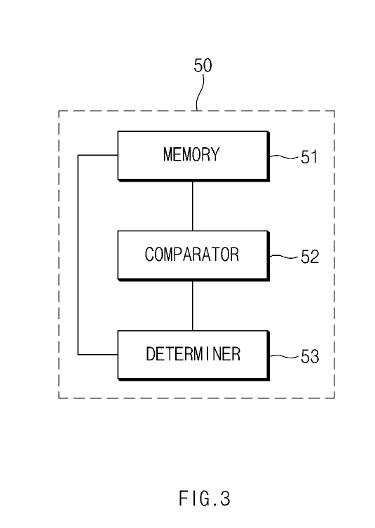

FIG. 3 is an exemplary detailed block diagram of an inspector according to an exemplary embodiment of the present disclosure. As illustrated in FIG. 3, the inspector 50 according to an exemplary embodiment may include a memory 51, a comparator 52, and a determiner 53. The components of the inspector 50 may be operated by the controller.

First, the memory 51 may be configured to store reference parameter that corresponds to the charging currents. The comparator 52 may then be configured to compare the reference parameter stored at the memory 51 with the charging parameter curve received via the communicator 30. The determiner 53 may be configured to determine whether the charging system operates normally, based on the comparison result. In other words, the determiner 53 may be configured to determine that the operation is normal (e.g., without failure or error) when a difference between the parameter of the charging system and the reference parameter is within a threshold range, while determining abnormal (e.g., a malfunction or error) when the threshold range is exceeded.

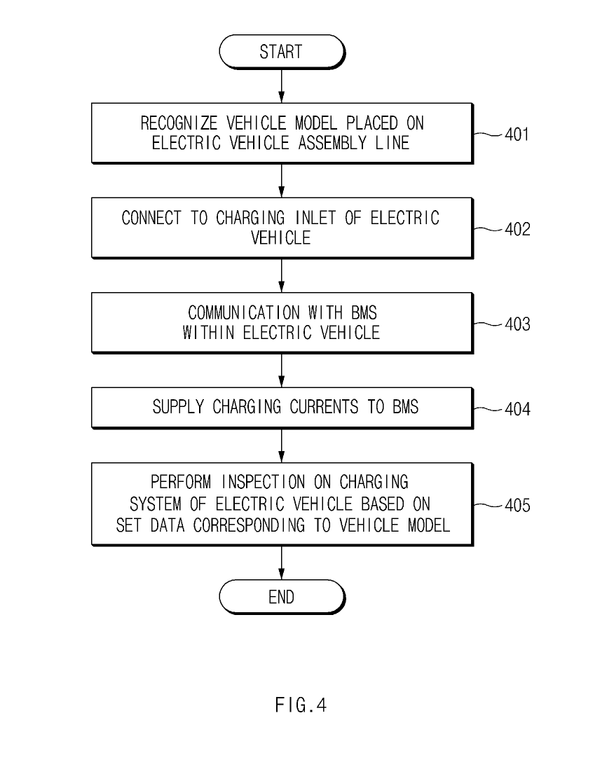

FIG. 4 is an exemplary flowchart illustrating a method of inspecting a charging system of an electric vehicle according to an exemplary embodiment of the present disclosure. First, at step 401, the vehicle model recognizer 10 may be configured to recognize or detect a vehicle model (e.g., vehicle type) placed on an electric vehicle assembly line. In other words, the controller may be configured to receive the recognized vehicle model. At step 402, the connection portion 20 may be connected to the charging inlet of the electric vehicle. Then, at step 403, the communicator 30 may be configured to communicate with the battery management system (BMS) within the electric vehicle via the connection portion 20.

At step 404, the charger 40 may be configured to supply charging currents to the BMS via the connection portion 20. The inspector 50 may then be configured to inspect, at step 405, the charging system of the electric vehicle, based on the set data that corresponds to the vehicle model as recognized by the vehicle model recognizer 10. In other words, the inspector 50 may be configured to operate the charger 40 to supply charging currents in a charging scheme that corresponds to the vehicle model and determine whether the charging system operates normally by comparing the charging parameter that corresponds to the charging currents with the reference parameter.

As described above, according to the exemplary embodiment of the present disclosure, in inspecting a charging system of an electric vehicle on an electric vehicle assembly line to determine whether the charging system operates normally, the present disclosure provides an effect of enhanced reliability of a completed vehicle (e.g., a manufactured vehicle), since it may be possible to complete rapid inspection on the completed form of the electric vehicle prior to shipping of the vehicle, by inspecting a communication section within the electric vehicle based on a controller area network (CAN) communication, supplying charging currents while gradually increasing the same, and inspecting a charging section by monitoring subsequent charging parameter curve and waveforms.

Further, in inspecting a charging system of an electric vehicle on an electric vehicle assembly line to determine whether the charging system operates normally, the present disclosure provides an effect of enabling inspection to be performed on the charging system of the electric vehicle without requiring a necessary inspection program for inspection of the charging system of electric vehicle to be stored on the BMS within the electric vehicle, by inspecting a communication section within the electric vehicle based on a controller area network (CAN) communication, supplying charging currents while gradually increasing the same, and inspecting a charging section by monitoring subsequent charging parameter curve and waveforms.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for inspecting a charging system of an electric vehicle, comprising:
a vehicle model recognizer configured to recognize a vehicle model disposed on an electric vehicle assembly line;
a connection portion connected to a charging inlet of the electric vehicle;
a communicator configured to communicate with a battery management system (BMS) within the electric vehicle via the connection portion;
a charger configured to supply charging currents to the BMS via the connection portion; and
an inspector configured to inspect the charging system of the electric vehicle, based on set data that corresponds to the recognized vehicle model.

2. The apparatus according to claim 1, wherein the inspector is configured to:
operate the charger to supply the charging currents in a charging scheme that corresponds to the vehicle model;
receive a charging parameter that corresponds to the charging currents via the communicator; and
determine whether the charging system operates without error, by comparing the received charging parameter with a reference parameter.

3. The apparatus according to claim 2, wherein the inspector includes:
a memory configured to store the reference parameter that corresponds to the charging currents;
a comparator configured to compare the reference parameter stored at the memory with the charging parameter received via the communicator; and
a determiner configured to determine that the operation is without error when a difference between the charging parameter and the reference parameter is within a threshold range, while determining a malfunction when the threshold range is exceeded.

4. The apparatus according to claim 2, wherein the inspector is configured to operate the charger to supply the charging currents when communication state with the BMS is without error.

5. The apparatus according to claim 1, further comprising:
a personal computer (PC) connection portion configured to transmit a result of inspection to an external personal computer.

6. The apparatus according to claim 1, wherein the charging system is classified into a communication section and a charging section, in which the communication section includes a wiring and a connector between the charging inlet of the electric vehicle and the BMS, and the BMS, while the charging section includes a wiring and a connector between the BMS and a high voltage battery and a circuit of the high voltage battery.

7. The apparatus according to claim 1, wherein the vehicle model recognizer is configured to recognize a vehicle model based on a barcode.

8. A method of inspecting a charging system of an electric vehicle, comprising:
recognizing, by a vehicle model recognizer, a vehicle model disposed on an electric vehicle assembly line;
connecting, by a connection portion, to a charging inlet of the electric vehicle;
communicating, by a communicator, with a battery management system (BMS) within the electric vehicle;
supplying, by a charger, charging currents to the BMS via the connection portion; and
inspecting, by an inspector, the charging system of the electric vehicle based on set data that corresponds to the recognized vehicle model.

9. The method according to claim 8, wherein the inspecting includes:
operating the charger to supply the charging currents in a charging scheme that corresponds to the vehicle model; and
determining whether the charging system operates without error, by comparing a charging parameter that corresponds to the charging currents with a reference parameter. to 10. The method according to claim 9, wherein the determination of whether the charging system operates without error includes:
storing the reference parameter that corresponds to the charging currents;
comparing the reference parameter stored at a memory with the charging parameter received via the communicator; and
determining that the operation is without error when a difference between the charging parameter and the reference parameter is within a threshold range; and
determining a malfunction when the difference between the charging parameter and the reference parameter is greater than the threshold range.

11. The method according to claim 9, wherein the operating of the charger includes operating the charger to supply the charging currents when communication state with the BMS is without error.

12. The method according to claim 8, further comprising:
transmitting a result of inspection to an external personal computer.

13. The method according to claim 8, wherein the charging system is classified into a communication section and a charging section, in which the communication section includes a wiring and a connector between the charging inlet of the electric vehicle and the BMS, and the BMS, while the charging section includes a wiring and a connector between the BMS and a high voltage battery and a circuit of the high voltage battery.

14. The method according to claim 8, wherein the recognizing of the vehicle model includes recognizing the vehicle model based on a barcode. to 15. A non-transitory computer readable medium containing program instructions executed by a controller, the computer readable medium comprising:
program instructions that receive a recognized vehicle model of a vehicle disposed on an electric vehicle assembly line;
program instructions that communicate with a battery management system (BMS) within the electric vehicle;
program instructions that supply charging currents to the BMS via a connection portion that connects to a charging inlet of the electric vehicle; and
program instructions that inspect the charging system of the electric vehicle based on set data that corresponds to the recognized vehicle model.

16. The non-transitory computer readable medium of claim 15, further comprising:
program instructions that supply the charging currents in a charging scheme that corresponds to the vehicle model; and
program instructions that determine whether the charging system operates without error, by comparing a charging parameter that corresponds to the charging currents with a reference parameter.

17. The non-transitory computer readable medium of claim 16, wherein the program instructions that determine whether the charging system operates without error include:
program instructions that store the reference parameter that corresponds to the charging currents;
program instructions that compare the reference parameter stored at a memory with the charging parameter received via the communicator; and
program instructions that determine that the operation is without error when a difference between the charging parameter and the reference parameter is within a threshold range; and
program instructions that determine a malfunction when the difference between the charging parameter and the reference parameter is greater than the threshold range.
